(19) United States
(12) Patent Application Publication
(10) Pub. No.: US 2009/0285308 A1
(43) Pub. Date: Nov. 19, 2009

(54) Deblocking algorithm for coded video

(75) Inventors: Kannan Panchapakesan, Chennai (IN); Paul Eric Haskell, Saratoga, CA (US); Andrew W. Johnson, Cupertino, CA (US)

Correspondence Address: FISH & RICHARDSON P.C., PO BOX 1022, MINNEAPOLIS, MN, 55440-1022, US

(73) Assignee: Harmonic Inc., Sunnyvale, CA (US)

(21) Appl. No.: 12/152,484

(22) Filed: May 14, 2008

(51) Int. Cl. H04N 7/26

(52) U.S. Cl. 375/240.24; 375/E07.19

(57) ABSTRACT

Methods, systems and computer program products for providing a deblocking algorithm to one or more blocks in a picture are described. A filtered block may result for each deblocked block. Each filtered block may then be combined to generate a decoded deblocked picture. This process may subsequently be applied to a next picture in a group of pictures resulting in a deblocking of a coded video sequence.

### TECHNICAL FIELD

The subject matter of this application is generally related to video and image processing.

### BACKGROUND

Video data transmission has become increasingly popular, and the demand for video streaming also has increased as digital video provides significant improvement in quality over conventional analog video in creating, modifying, transmitting, storing, recording and displaying motion videos and still images. A number of different video coding standards have been established for coding these digital video data. The Moving Picture Experts Group (MPEG), for example, has developed a number of standards including MPEG-1, MPEG-2 and MPEG-4 for coding digital video. Other standards include the International Telecommunication Union Telecommunications (ITU-T) H.264 standard and associated proprietary standards. Many of these video coding standards allow for improved video data transmission rates by coding the data in a compressed fashion. Compression can reduce the overall amount of video data required for effective transmission. Most video coding standards also utilize graphics and video compression techniques designed to facilitate video and image transmission over low-bandwidth networks.

Video compression technology, however, can cause visual artifacts that severely degrade the visual quality of the video. One artifact that degrades visual quality is blockiness. Blockiness manifests itself as the appearance of a block structure in the video. One conventional solution to remove the blockiness artifact is to employ a video deblocking filter during post-processing or after decompression. Conventional deblocking filters can reduce the negative visual impact of blockiness in the decompressed video. These filters, however, generally require a significant amount of computational complexity at the video decoder and/or encoder, which translates into higher cost for obtaining these filters and intensive labor in designing these filters.

### SUMMARY

A deblocking algorithm to one or more blocks in a picture is described. A filtered block may result for each deblocked block. Each filtered block may then be combined to generate a decoded deblocked picture. This process may subsequently be applied to a next picture in a group of pictures resulting in a deblocking of a coded video sequence.

In some implementations, a method includes: receiving a coded video picture, the coded video picture having one or more set of blocks, each block including one or more pixels and at least one block having blocking artifacts; deblocking the one or more set of blocks in the picture; and generating a decoded deblocked picture based on the deblocked blocks, the blocking artifacts being substantially removed from the decoded deblocked picture.

In other implementations, a method includes: receiving a digital video signal representing a digitally compressed video image including a plurality of pixels arranged horizontally and vertically in a two-dimensional array; determining one or more pixel values associated with one or more pixels disposed diagonally relative to a pixel; determining a threshold value based on the one or more pixel values; comparing the threshold value against one or more parameters associated with the pixel with the blocking artifact; and filtering the pixel if it is determined that the one or more parameters exceed the threshold value.

In other implementations, a method includes: receiving a digital video signal representing a digitally compressed video image including a plurality of pixels arranged in a two-dimensional array; and determining a boundary condition in the received signal, the boundary condition being determined in the digitally compressed video image according to a smoothness measurement associated with one or more pixels arranged in a diagonal direction.

In other implementations, a method includes: identifying a macro-block associated with a blocking artifact, the macro-block having a plurality of pixels and including a uniform block corresponding to a region having substantially uniform pixel values and a non-uniform block corresponding to a region having non-uniform pixel values; calculating a gradient value for each pixel; comparing the gradient value to a threshold value to determine one or more pixels associated with a blocking artifact; and filtering the one or more pixels whose gradient value exceeds the threshold value.

In other implementations, a method includes: receiving a portion of an image, the portion including a boundary and first and second contiguous pixels disposed on opposite sides of the boundary, the first and second pixels having respective first and second pixel values; determining a boundary value from the first and second values; comparing the boundary value against a threshold value; and minimizing a difference between the first and second values if the boundary value exceeds the threshold value.

In other implementations, a method includes: detecting one or more discontinuities in proximity to block boundaries of an image; determining whether any of the discontinuities are artificial discontinuities based on a threshold value; and smoothing the one or more discontinuities that are determined to be artificial discontinuities.

In other implementations, a system includes: a processor and a computer-readable medium coupled to the processor and having instructions stored thereon, which, when executed by the processor, causes the processor to perform operations comprising: receiving a coded video picture, the coded video picture having one or more set of blocks, each block including one or more pixels and at least one block having blocking artifacts; deblocking the one or more set of blocks in the picture; and generating a decoded deblocked picture based on the deblocked blocks, the blocking artifacts being substantially removed from the decoded deblocked picture.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a video bitstream used in an example digital video coding standard whose block components can be deblocked using a deblocking algorithm, resulting in a filtered block.

FIG. 2 is a flow diagram of an example method for deblocking a picture that includes blocking artifacts.

FIG. 3 is a block diagram showing an example diagonal neighborhood for a pixel in a block.

FIG. 4 is a flow chart of an example method for determining a likeness value for a pixel in a deblocking algorithm.

FIG. 5 is a flow diagram of an example method for determining a threshold value for a pixel in a deblocking algorithm.

FIGS. 6A, 6B, and 6C are a flow diagram of an example method for a deblocking algorithm.

FIGS. 7A and 7B are pictures of a progressive frame of video data before and after deblocking, respectively.

FIGS. 8A and 8B are additional pictures of a progressive frame of video data before and after deblocking, respectively.

FIGS. 9A and 9B are pictures of an interlaced frame of video data before and after deblocking, respectively.

FIGS. 10A and 10B are additional pictures of an interlaced frame of video data before and after deblocking, respectively.

FIGS. 11A and 11B are additional pictures of an interlaced frame of video data before and after deblocking, respectively.

FIG. 12 is a block diagram of an example system for implementing the various operations described in FIGS. 1-6.

Like reference symbols in the various drawings indicate like elements.

### DETAILED DESCRIPTION

### System Overview

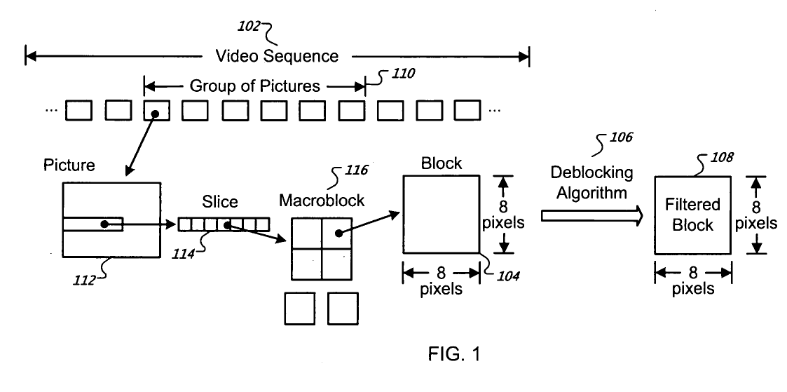

FIG. 1 is a block diagram showing the processing of a video bitstream, which can also be referred to as a video sequence 102. The video sequence 110 can include a group of pictures 110. An individual picture 112 can be processed to identify a slice 114. Included within a slice are one or more macroblocks 116. An individual block 104 of the macroblock 116 can be processed by a deblocking algorithm 106 to produce a filtered block 108. For example, a sequence of pictures can represent a digital video stream of data, where each picture includes an array of pixels. Uncompressed digital video data can result in large amounts of data that if stored for future viewing, for example, may require large amounts of data storage space (e.g., disk space or memory space). Additionally, for example, if a device transmits the uncompressed digital video data to another device, long transmissions times can occur due to the large amount of data transferred. Therefore, video compression can be used to reduce the size of the digital video data, resulting in reduced data storage needs and faster transmission times.

For example, an MPEG-2 coded video is a stream of data that includes coded video sequences of groups of pictures. The MPEG-2 video coding standard can specify the coded representation of the video data and the decoding process required to reconstruct the pictures resulting in the reconstructed video. The MPEG-2 standard aims to provide broadcast as well as HDTV image quality with real-time transmission using both progressive and interlaced scan sources.

In the implementation of FIG. 1, a video sequence 102 can include one or more sequence headers. The video sequence 102 can include one or more groups of pictures (e.g., group of pictures 110), and can end with an end-of-sequence code. The group of pictures (GOP) 110 can include a header and a series of one or more pictures (e.g., picture 112). A picture (e.g., picture 112) can be a primary coding unit of a video sequence (e.g., video sequence 102). In some implementations, a picture can be represented by three rectangular matrices. One matrix can represent the luminance (Y) component of the picture. The remaining two matrices can represent the chrominance values (Cr and Cb).

In some implementations, the luminance matrix can have an even number of rows and columns. Each chrominance matrix can be one-half the size of the luminance matrix in both the horizontal and vertical direction because of the subsampling of the chrominance components relative to the luminance components. This can result in a reduction in the size of the coded digital video sequence without negatively affecting the quality because the human eye is more sensitive to changes in brightness (luminance) than to chromaticity (color) changes.

In some implementations, a picture (e.g., picture 112) can be divided into a plurality of horizontal slices (e.g., slice 114), which can include one or more contiguous macroblocks (e.g., macroblock 116). For example, in 4:2:0 video frame, each macroblock includes four 8×8 luminance (Y) blocks, and two 8×8 chrominance blocks (Cr and Cb). If an error occurs in the bitstream of a slice, a video decoder can skip to the start of the next slice and record the error. The size and number of slices can determine the degree of error concealment in a decoded video sequence. For example, large slice sizes resulting in fewer slices can increase decoding throughput but reduce picture error concealment. In another example, smaller slice sizes resulting in a larger number of slices can decrease decoding throughput but improve picture error concealment. Macroblocks can be used as the units for motion-compensated compression in an MPEG-2 coded video sequence.

A block (e.g., block 104) can be the smallest coding unit in an MPEG coded video sequence. For example, an 8×8 pixel block (e.g., block 104) can be one of three types: luminance (Y), red chrominance (Cr), or blue chrominance (Cb). In some implementations, visible block boundary artifacts can occur in MPEG coded video streams. Blocking artifacts can occur due to the block-based nature of the coding algorithms used in MPEG video coding. These artifacts can lead to significantly reduced perceptual quality of the decoded video sequence.

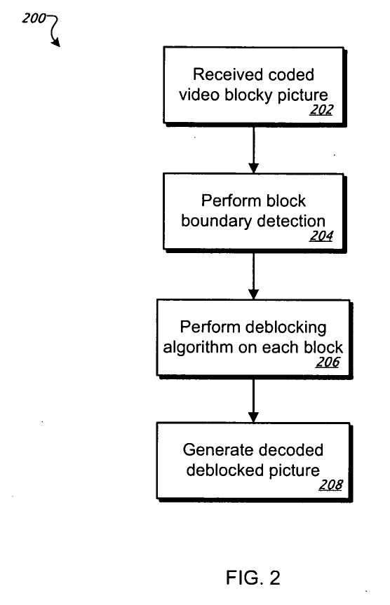

As shown in FIG. 1, the application of a deblocking algorithm 106 to selected pixels in blocks of an MPEG coded image can reduce the blockiness in the coded video. The deblocking algorithm can remove blocking artifacts from coded video after the video has been decoded back into the pixel domain, resulting in the filtered block 108. The deblocking algorithm 106 can act as a filter that can reduce the negative visual impact of blockiness in a decoded video sequence. The deblocking algorithm 106 can be applied to luminance blocks as well as chrominance blocks. FIGS. 2-6 describe the deblocking algorithm in greater detail.

FIG. 2 is a flow diagram of an example method 200 for deblocking a picture that includes blocking artifacts. The method 200 starts by receiving a coded video picture that can include blocking artifacts (step 202). The coded video picture (e.g., picture 112) can include blocking artifacts that can degrade the quality of the decoded video sequence. The method 200 can determine the block boundaries in the coded video picture (step 204). As described in FIG. 1, the picture (e.g., picture 112) can be divided into a plurality of horizontal slices (e.g., slice 114), which can include one or more contiguous macroblocks (e.g., macroblock 116). Each macroblock can include multiple luminance and chrominance blocks.

A deblocking algorithm can be applied to each block in the picture resulting in a filtered block for each deblocked block (e.g., filtered block 108 is the result of applying deblocking algorithm 106 to block 104) (step 206). Each filtered block is combined to generate a decoded deblocked picture (step 208). The method 200 can be applied to the next picture in a group of pictures resulting in the deblocking of a coded video sequence.

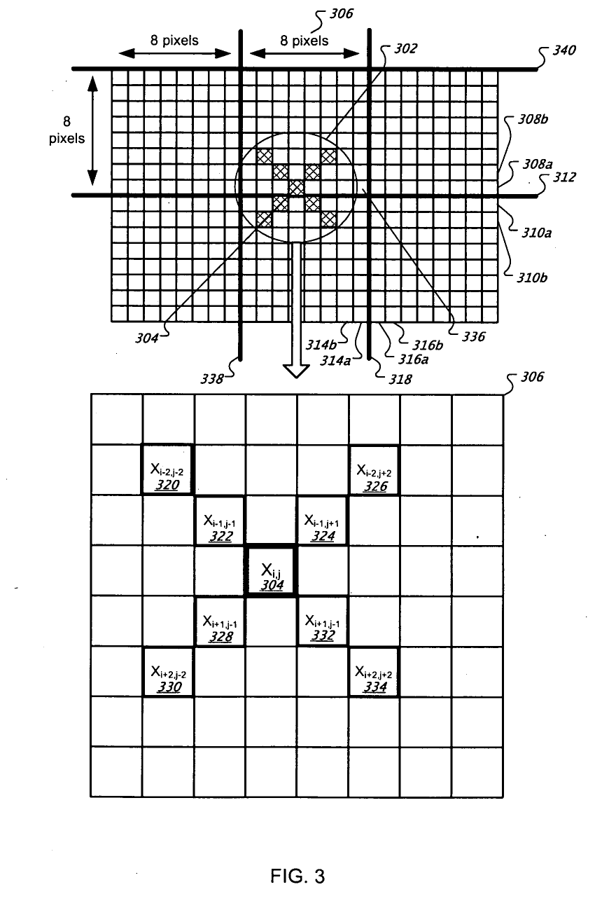

FIG. 3 is a block diagram showing an example diagonal neighborhood 302 for a pixel 304 in a block 306. A deblocking algorithm can use the diagonal neighborhood 302 for filtering the pixel 304. In some implementations, pixels selected for use by the deblocking algorithm within a block can be selected from one or more adjacent rows and one or more adjacent columns to the block boundary. In the example of FIG. 3, pixels selected for use by the deblocking algorithm within a block can be selected from the two adjacent rows and the two adjacent columns to the block boundary.

The deblocking algorithm can apply a diagonal filter to every pixel selected for use by the algorithm (e.g., every pixel in the two rows on either side of a block boundary and every pixel in the two columns on either side of a block boundary) in the decoded picture. The filtering of the pixels can result in the apparent smoothing or blurring of picture data near, for example, the boundaries of a block. This smoothing can reduce the visual impact of the blocking artifacts, resulting in decoded video sequences that exhibit little or no “blockiness”.

In some implementations, a video sequence can be in the form of interlaced video where a frame of a picture includes two fields interlaced together to form a frame. The interlaced frame can include one field with the odd numbered lines and another field with the even numbered lines. One interlaced frame includes sampled fields (odd numbered lines and even numbered lines) from two closely spaced points in time. The coded video data includes coded data for each field of each frame. The deblocking algorithm can be applied to each interlaced field. For example, television video systems can use interlaced video.

In some implementations, a video sequence can be in the form of non-interlaced or progressively scanned video where all the lines of a frame are sampled at the same point in time. The deblocking algorithm can be applied to each frame. For example, desktop computers can output non-interlaced video for use on a computer monitor. Additionally, the deblocking algorithm can decide adaptively, pixel by pixel or block by block, whether to filter individual fields or complete frames.

The deblocking algorithm can assume that the positions of the block boundaries in the coded video have been determined prior to encoding (i.e., a block boundary grid may be known prior to the decoding of the encoded image). Therefore, the deblocking algorithm can determine the pixels within each block that can be filtered.

In some implementations, the luminance (Y), and chrominance (Cb, Cr) values of a pixel (e.g., xᵢⱼ) situated on any of the four rows (two rows on either side of a horizontal block boundary) or four columns (two columns on either side of a vertical block boundary) around a block boundary can be replaced by a pixel value (e.g., y_{i,j}) that is computed using [1]:

yᵢⱼ=1/nΣₖzₖ [1]

where n is the total number of pixels in the diagonal neighborhood, including the pixel for filtering, j is the horizontal location of the pixel for filtering in the block, i is the vertical location of the pixel for filtering in the block, and k refers to the location of each of the pixels in a diagonal neighborhood of location (i, j), relative to and including the pixel for filtering. Each pixel in the diagonal neighborhood can have a likeness value, zₖ, calculated based the comparison of its value with the value of the pixel being filtered.

In some implementations, a pixel filter can be a diagonal neighborhood that can include an “X” shaped filter with two pixels on each of the four corners of the selected pixel. In some implementations, the “X” shaped filter can include more or less pixels. The selection of the number of pixels used to form an “X” shaped filter can be determined empirically by examining the results of the pixel filtering by the deblocking algorithm on resultant video sequences. The selection can also be based on output quality as well as processing throughput. In some implementations, the configuration of a pixel filter can take on other shapes that surround and include the pixel for filtering. For example, a pixel filter can be in the form of a “+” pattern in which a number of pixels are selected directly above, below, to the right and to the left of a pixel for filtering. In another example, a pixel filter can be in a square pattern that includes all of the pixels surrounding a pixel for filtering.

In the example of FIG. 3, a deblocking algorithm can filter pixel 304. The deblocking algorithm can select pixels located in the two adjacent rows (rows 308a, 308b and rows 310a, 310b) to horizontal block boundary 312, and the two adjacent columns (columns 314a, 314b and columns 316a, 316b) to vertical block boundary 318. Horizontal block boundary 340 and vertical block boundary 338 are also boundaries for block 306. For example, block 306 can be included in a macroblock in a slice from a picture (e.g., picture 112). However, block 306 is not representative of an edge block. The deblocking algorithm can proceed through all of the decoded data selecting pixels along horizontal and vertical boundaries of all the blocks in each picture.

The luminance (Y), and chrominance (Cb, Cr) values of pixel 304 (e.g., xᵢⱼ) can be replaced by a filtered pixel value (e.g., y_{i,j}) that is computed, using Equation 1 above, where k refers to the position of the pixels in the “X” shaped diagonal neighborhood 302, as well as the pixel 304. As shown in FIG. 3, n=9, and the pixel positions in the diagonal neighborhood 302 are as follows: pixel 320 is in position k₀=(i−2,j−2), pixel 322 is in position k₁=(i−1,j−1), pixel 324 is in position k₂=(i−1,j+1), pixel 326 is in position k₃=(i−2,j+2), pixel 304 is in position k₄=(i,j), pixel 328 is in position k₅=(i+1,j−1), pixel 330 is in position k₆=(i+2,j−2), pixel 332 is in position k₇=(i+1,j+1), and pixel 334 is in position k₈=(i+2,j+2).

Equation 1 may use a modified average to compute the filtered pixel value. In some implementations, equation 1 may be supplemented with an additional algorithm implementing a median filter technique for computing a filtered pixel value to be applied with the deblocking algorithm.

In some implementations, the deblocking algorithm can filter a corner pixel in a block (e.g., pixel 336) twice. For example, the deblocking algorithm can horizontally filter the corner pixel, and then vertically filter the resultant horizontally filtered corner pixel. In another example, the horizontal filtering of the corner pixel can occur first, with vertical filtering of the resultant horizontally occurring next. In some implementations, the deblocking algorithm may select whether a corner pixel is filtered twice, both vertically and horizontally, or if only one type of filtering for the corner pixel is selected, either vertical or horizontal filtering.

The deblocking algorithm can filter designated pixels located adjacent to horizontal and vertical block boundaries. In some implementations, the deblocking algorithm may not filter pixels located on the border of a picture (located along the vertical and horizontal edges). The algorithm may only filter pixels located in the interior of a picture that are located at or near vertical and horizontal block boundaries.

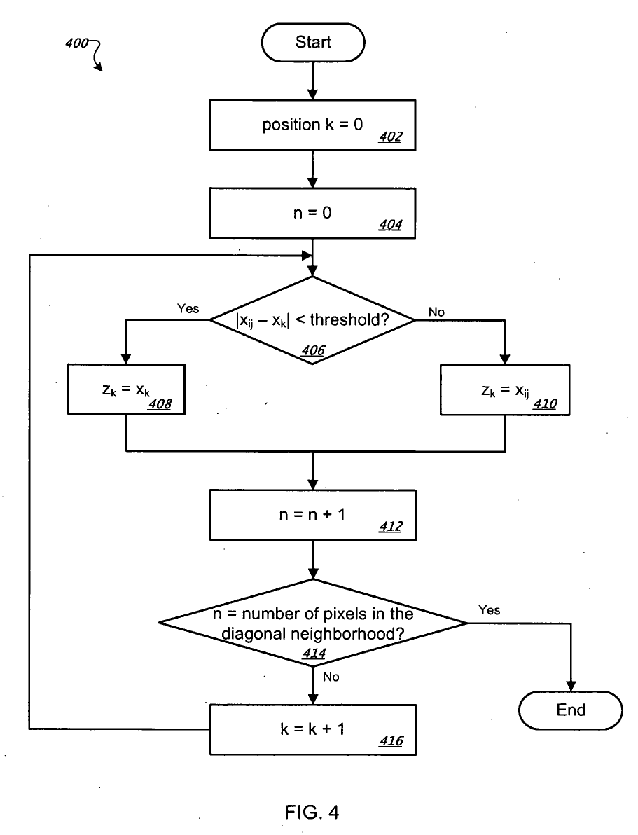

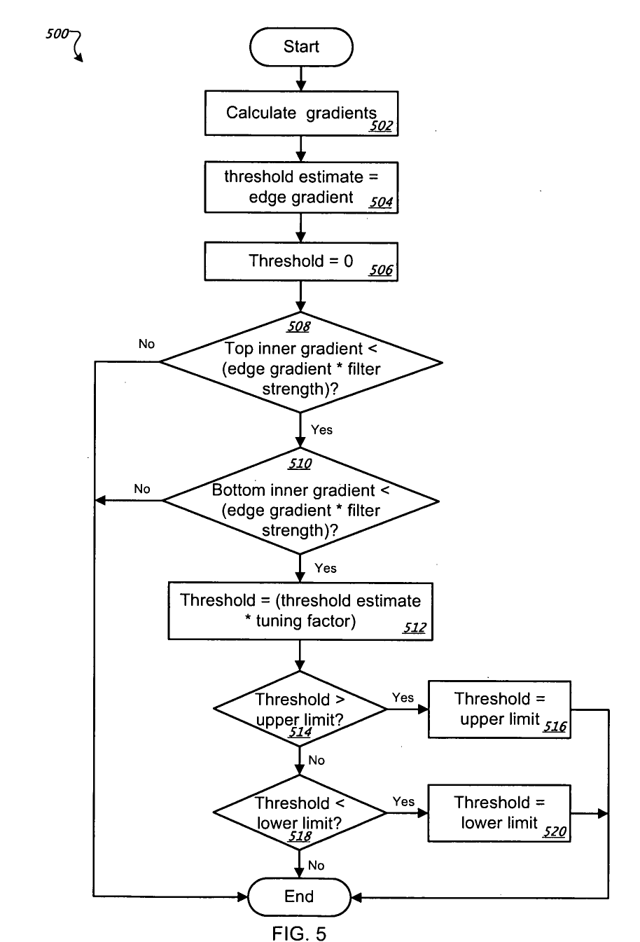

FIG. 4 is a flow chart of a method 400 for determining a likeness value for a pixel in a deblocking algorithm. The method 400 can use Equation 1 described in FIG. 3. A likeness value for a pixel in position k in the diagonal neighborhood of the pixel for filtering (e.g., xᵢⱼ) can be the value, zₖ, in Equation 1. The method 400 starts by setting the position, k, of the pixel in the diagonal neighborhood equal to the pixel at position 0 (step 402). The number of pixels included in the diagonal neighborhood, which includes the pixel for filtering, n, is set equal to zero (step 404). The absolute value of the result of the difference between the value of the pixel for filtering, xᵢⱼ, and the value of the currently selected pixel in the diagonal neighborhood, xₖ, is determined. If this value is less than a predetermined threshold value (step 406), the likeness value for the pixel at position k, zₖ, is set equal to the value of the currently selected pixel in the diagonal neighborhood, xₖ (step 408). If the absolute value of the difference between the two pixel values is not less than a predetermined threshold value (step 406), the likeness value for the pixel at position k, zₖ, is set equal to the value of the pixel for filtering, xᵢⱼ (step 410). FIG. 5 will describe the method used to determine the threshold value.

The method 400 continues and the number of pixels in the diagonal neighborhood is incremented (step 412). If there are more pixels in the diagonal neighborhood (n is not equal to the number of pixels in the diagonal neighborhood) (step 414), the diagonal neighborhood pixel position, k, is incremented to refer to the next pixel in the diagonal neighborhood (step 416). The method 400 continues to step 406 to process the next pixel. If there are no more pixels in the diagonal neighborhood (n is equal to the number of pixels in the diagonal neighborhood) (step 414), the method 400 ends.

FIG. 5 is a flow diagram of a method 500 for determining a threshold value for a pixel in a deblocking algorithm. The deblocking algorithm can perform the method 500 for each pixel filtered. Therefore, the threshold value can be unique per filtered pixel to take into account the diagonal neighborhood pixel values while filtering. The deblocking algorithm can use the threshold value for pixel filtering in order to strike a balance between blockiness reduction and excessive blurring for pixel compensation. A threshold value for a pixel undergoing filtering can be determined by using neighboring pixels to the pixel for filtering.

The method 500 can calculate a threshold value for a luminance (Y) sample of a pixel for filtering, while dealing with horizontal block boundaries using vertical gradients. A method for determining a threshold value for the luminance (Y) sample of the pixel for filtering, while dealing with vertical block boundaries can be determined by a similar method using horizontal gradients. The same methods for determining threshold values for a luminance (Y) sample of a pixel for filtering can be used for determining a threshold value for each of the chrominance samples (e.g., Cr, Cb) of the pixel by using the chrominance samples in their native resolution.

The threshold value for a pixel for filtering is set to zero by default. The zero value indicates that no filtering is performed on the pixel. However, if both the inner gradients (the gradients on either side of the block boundary) are significantly different from the edge gradient for the pixel for filtering, then the threshold value used by the deblocking algorithm for pixel filtering for the pixel can be set to a threshold estimate (the edge gradient value) multiplied by a tuning factor.

The method 500 for determining a threshold value for a pixel for filtering (e.g., xᵢⱼ, where j is the horizontal location of the pixel, x, in a block and i is the vertical location of the pixel, x, in a block) starts by calculating the three gradients for the pixel (step 502): the top inner gradient, the edge gradient, and the bottom inner gradient. The gradients for the luminance value [Y] for the pixel can be calculated using the following equations:

top inner gradient=|(orig[Y][i−1][j]−orig[Y][i−2][j])|

edge gradient=|orig[Y][i][j]−orig[Y][i−1][j]|

bottom inner gradient=|orig[Y][i+1][j]−orig[Y][i][j]|

where “| |” indicates the absolute value of the difference of the two elements of the equation, j is the horizontal location of a pixel in a block, i is the vertical location of a pixel in a block, and orig[Y] indicates the unfiltered luminance value [Y] of the pixel.

The method 500 then sets the threshold estimate equal to the edge gradient (step 504). The threshold value is then set equal to zero (step 506) by default. A filter strength can be a value determined empirically for the deblocking algorithm for pixel filtering that can be selected to strike a balance between blockiness reduction and excessive blurring of the deblocked video sequence. If the top inner gradient is less than the edge gradient multiplied by the filter strength (step 508), the method 500 next determines if the bottom inner gradient is less than the edge gradient multiplied by the filter strength (step 510). If the bottom inner gradient is less than the edge gradient multiplied by the filter strength, the threshold value is set equal to the threshold estimate multiplied by a tuning factor (step 512). The tuning factor can also be determined empirically to strike a balance between blockiness reduction and excessive blurring of the deblocked video sequence.

Method 500 then clips the threshold value to either a minimum value or a maximum value. The clipping thresholds can also be determined empirically to strike a balance between blockiness reduction and excessive blurring of the deblocked video sequence. The method 500 checks if the threshold value is greater than an upper clipping limit (step 514). Clipping the threshold value to an upper limit can correct for spurious cases that can lead to excessive blurring after pixel filtering. If the threshold value is greater than the upper clipping limit, the threshold value is set equal to the upper clipping limit (step 516) and the method 500 ends. If the threshold value is not greater than the upper clipping limit (step 514), the threshold value is then checked to see if it is less than the lower clipping limit (step 518). If the threshold value is not less than the lower clipping limit, the method 500 ends. If the threshold value is less than the lower clipping limit, the threshold value is set equal to the lower clipping limit (step 520) and the method 500 ends.

If the top inner gradient is not less than the edge gradient multiplied by the filter strength (step 508), the method 500 ends and the threshold value remains set equal to zero and the pixel is not filtered. If the bottom inner gradient is not less than the edge gradient multiplied by the filter strength (step 510), the method 500 ends and the threshold value remains set equal to zero and the pixel is not filtered.

In some implementations, empirical testing determined that setting the tuning factor equal to two, the filter strength equal to ⅔, the upper limit of the clipping threshold equal to 80, and the lower limit of the clipping threshold equal to zero produced deblocked decoded video sequences that balanced blockiness reduction and excessive blurring.

As described with reference to FIG. 3, corner pixels can be filtered twice, horizontally and then vertically. However, in some implementations, threshold value calculations for a corner pixel for the horizontal as well as the vertical filtering step are done with unfiltered pixel values (the original pixel value) rather than using the horizontal filtered pixel value for determining the vertical filtered pixel value. Empirical results have determined that calculating the threshold value for a corner pixel in this manner can produce better deblocking of the video sequence leading to visually better results.

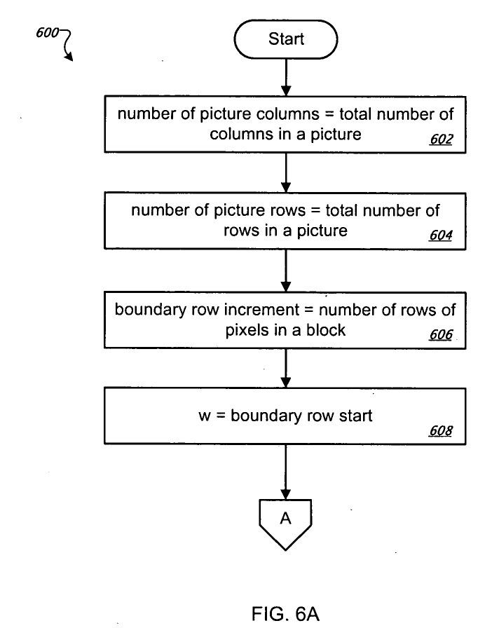

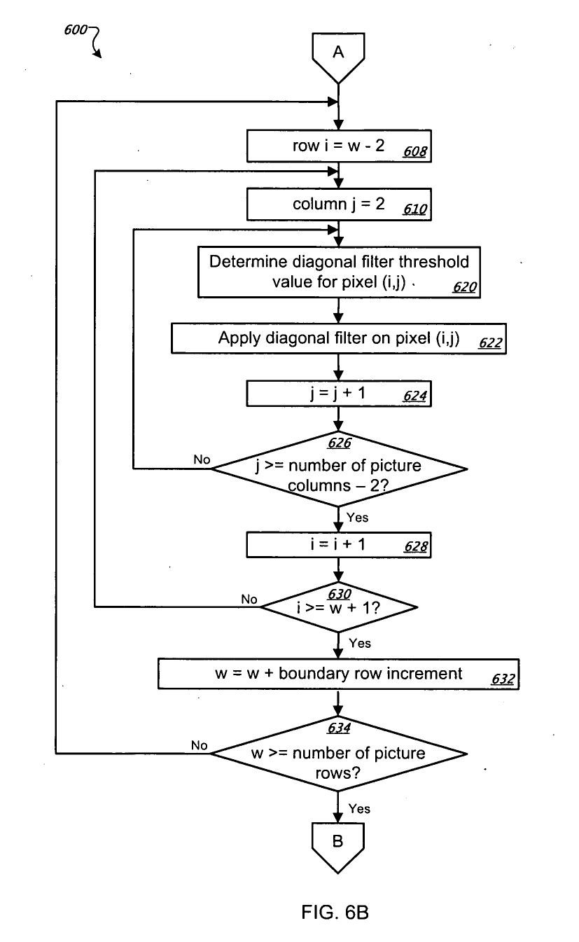

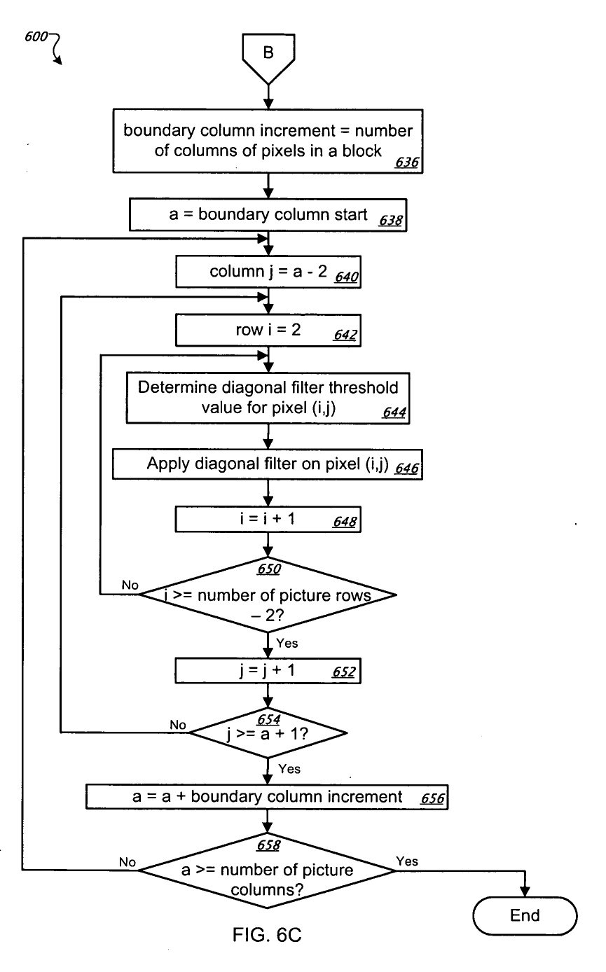

FIGS. 6A, 6B, and 6C are a flow diagram of a method 600 for a deblocking algorithm. The method 600 is for an example deblocking algorithm for a picture divided into 8×8 blocks that filters pixels included in the two rows on either side of a horizontal block boundary, and the two columns on either side of a vertical block boundary. The method 600 also uses a diagonal neighborhood, as described in FIG. 3, where the pixel filter is an “X” shaped filter with two pixels on each of the four corners of the selected pixel for filtering, which is in the pixel in the center of the “X”.

The method 600 starts in FIG. 6A by setting the number of picture columns equal to the total number of columns included in a picture (step 602). The method 600 also sets the number of picture rows equal to the total number of rows included in a picture (step 604). The method 600 continues by setting the boundary row increment equal to the number of rows of pixels in a block (step 606). For example, in a picture where the block size is 8×8, the boundary row increment is set equal to eight.

The top two rows of the top horizontal edge blocks in a picture may not be selected for filtering. Therefore, a boundary row start value, w, is set equal to the row number in the picture for the first row of pixels adjacent to a horizontal block boundary that is at the top of the block that borders the top horizontal edge block (step 606). For example, in a picture where the block size is 8×8, the boundary row start value, w, is set equal to eight. The method 600 can filter the pixels included in the two rows adjacent to either side of a horizontal block boundary. Therefore, referring to FIG. 6B, the starting row value, i, for the pixels for filtering in a picture is set equal to the boundary row start value, w, minus two (step 608). FIG. 6B shows the part of the method 600 that horizontally filters selected pixels.

The column value for the number of columns in a picture can start at zero for the first column. Therefore, the starting column value, j, for the pixels for filtering in a picture is set equal to two (step 610). This can allow the “X” shaped filter of the method 600 to include the two pixels on each of the four corners of the selected pixel for filtering, which is in the center of the “X”.

The pixel for filtering is located within the picture at a location specified by the row value, i, and the column value, j. A threshold value is determined for the selected pixel for filtering using a diagonal neighborhood as the filter (step 620). The threshold value for the selected pixel for filtering can be determined using the method 500, described in FIG. 5.

The method 600 applies the diagonal filter of the diagonal neighborhood to the pixel for filtering (step 622). A likeness value for the selected pixel for filtering can be determined using the method 400, as described in FIG. 4, by applying by the diagonal filter of the diagonal neighborhood to the pixel.

The method 600 proceeds to the next pixel in the row by incrementing the column value, j, by one (step 624). Since the column value starts at zero for the first column in a picture, the last column in a picture is equal to the total number of columns in a picture minus one. Therefore, the last filtered pixel in a row of a picture is located in the third column from the right edge of the picture. This can allow the “X” shaped filter of the method 600 to include the two pixels on each of the four corners of the selected pixel for filtering, which is in the center of the “X”.

If the column value, j, is less than the number of picture columns minus two (step 626), the method 600 can continue to step 620 to deblock the next pixel in the row by determining its threshold value and applying a diagonal filter. If in step 626, the column value, j, is greater than or equal to the number of picture columns minus two, the method 600 is at the end of the current row of pixels for filtering. The row value, i, is incremented by one (step 628). If the row value, i, is less than boundary row start value, w, plus one (step 630), the method 600 continues to step 610 and the column count is set equal to two. The deblocking algorithm can deblock a new row of pixels.

If the row value, i, is greater than or equal to the boundary row start value, w, plus one (step 630), the boundary row start value, w, is incremented by the boundary row increment (step 632). For example, in a picture where the block size is 8×8, the boundary row increment is set equal to eight and the boundary row start value, w, is incremented by eight.

The boundary row start value, w, is set to the first row of the next block that is adjacent to the next horizontal block boundary. If the boundary row start value, w, is less than the number of picture rows (step 634), there are more rows of pixels available for filtering and the method continues to step 608. If the boundary row start value, w, is greater than or equal to the total number of picture rows (step 634), the boundary row start value, w, is set to a row beyond the last row of the picture. In some implementations, as is the case for the top two rows of the top horizontal edge blocks in a picture, the pixels included in the bottom two rows of the bottom horizontal edge blocks of a picture are not filtered. Therefore, the method 600 continues to FIG. 6C and step 636.

FIG. 6C shows the part of the method 600 that vertically filters selected pixels. The method 600 continues by setting the boundary column increment equal to the number of columns of pixels in a block (step 604). For example, in a picture where the block size is 8×8, the boundary column increment is set equal to eight.

The left two columns of the leftmost vertical edge blocks in a picture may not be selected for filtering. Therefore, a boundary column start value, a, is set equal to the column number in the picture for the first column of pixels adjacent to a vertical block boundary that is at the leftmost end of the block that borders the leftmost vertical edge block (step 638). For example, in a picture where the block size is 8×8, the boundary column start value, a, is set equal to eight. The method 600 can filter the pixels included in the two columns adjacent to either side of a vertical block boundary. Therefore, referring to FIG. 6C, the starting column value, j, for the pixels for filtering in a picture is set equal to the boundary column start value, a, minus two (step 640).

The row value for the number of rows in a picture can start at zero for the first row. Therefore, the starting row value, i, for the pixels for filtering in a picture is set equal to two (step 642). This can allow the “X” shaped filter of the method 600 to include the two pixels on each of the four corners of the selected pixel for filtering, which is in the center of the “X”.

The pixel for filtering is located within the picture at a location specified by the row value, i, and the column value, j. A threshold value is determined for the selected pixel for filtering using a diagonal neighborhood as the filter (step 644). The threshold value for the selected pixel for filtering can be determined using the method 500, described in FIG. 5.

The method 600 applies the diagonal filter of the diagonal neighborhood to the pixel for filtering (step 646). A likeness value for the selected pixel for filtering can be determined using the method 400, as described in FIG. 4, by applying by the diagonal filter of the diagonal neighborhood to the pixel.

The method 600 proceeds to the next pixel in the column by incrementing the row value, i, by one (step 648). Since the row value starts at zero for the first row in a picture, the last row in a picture is equal to the total number of rows in a picture minus one. Therefore, the last filtered pixel in a column of a picture is located in the third row from the bottom edge of the picture. This can allow the “X” shaped filter of the method 600 to include the two pixels on each of the four corners of the selected pixel for filtering, which is in the center of the “X”.

If the row value, i, is less than the number of picture rows minus two (step 650), the method 600 can continue to step 644 to deblock the next pixel in the column by determining its threshold value and applying a diagonal filter. If in step 650, the row value, i, is greater than or equal to the number of picture rows minus two, the method 600 is at the end of the current column of pixels for filtering. The column value, j, is incremented by one (step 652). If the column value, j, is less than boundary column start value, a, plus one (step 654), the method 600 continues to step 642 and the row count is set equal to two. The deblocking algorithm can deblock a new column of pixels.

If the column value, j, is greater than or equal to the boundary column start value, a, plus one (step 654), the boundary column start value, a, is incremented by the boundary column increment (step 656). For example, in a picture where the block size is 8×8, the boundary column increment is set equal to eight and the boundary column start value, a, is incremented by eight.

The boundary column start value, a, is set to the first column of the next block that is adjacent to the next vertical block boundary. If the boundary column start value, a, is less than the number of picture columns (step 658), there are more columns of pixels available for filtering and the method continues to step 640. If the boundary column start value, a, is greater than or equal to the total number of picture columns (step 658), the boundary column start value, a, is set to a column beyond the last column of the picture. As is the case for the leftmost two columns of the leftmost vertical edge blocks in a picture, the pixels included in the rightmost two columns of the rightmost vertical edge blocks of a picture are not filtered. Therefore, the method 600 ends.

As shown in FIGS. 6A, 6B, and 6C the method 600 first horizontally filters selected pixels and then vertically filters selected pixels. In some implementations, selected pixels may be first vertically filtered and then horizontally filtered.

The complexity of the deblocking algorithm described in the method 600 can be summarized as follows. Let M×N be the resolution of the picture to be deblocked. Let a x b be the size of the blocks present in the picture. The number of vertical b-pixel block boundaries can be calculated as (M*N/a*b). The number of horizontal a-pixel block boundaries can be calculated as (M*N/a*b). The number of filtered vertical b-pixel boundaries can be calculated as (4*M*N/a*b). The number of filtered horizontal a-pixel boundaries can be calculated as: (4*M*N/a*b). The two pixel boundaries on either side of a block boundary can be processed. Therefore, the number of filtered vertical boundary pixels can be calculated as: (4*M*N/a) and the number of filtered horizontal boundary pixels can be calculated as: (4*M*N/b). The total number of filtered boundary pixels can be calculated as: (4*M*N[(a+b)/a*b].

The term samples in this instance refers to the luminance (Y), and chrominance (Cr, Cb) components of each pixel. For example, a 4:2:2 picture has twice as many samples as pixels. Application of the deblocking algorithm can be to all samples of a picture. Therefore, the number of filtered boundary samples can be calculated as: (8*M*N[(a+b)/a*b].

The worst-case complexity that may be needed to filter each sample is summarized as follows. The gradient calculations (step 502 of method 500 in FIG. 5) can utilize three subtraction operations and three absolute value operations. The threshold calculation (steps 508, 510, 512, 514, 516, 518 and 520 of method 500 in FIG. 5) can utilize two “if” operations, two multiply operations and one clipping operation. The filtered pixel sample calculation (Equation 1 and method 400 in FIG. 4) can utilize one multiply operation, eight “if” operations, sixteen subtraction operations, and one division operation.

Therefore, the total number of operations that may be utilized per sample is nineteen subtraction operations, three multiply operations, one division operation, ten “if” operations, three absolute value operations, and one clipping operation. All of these operations can be carried out for a total of (8*M*N[(a+b)/a*b) samples in a picture. In some implementations, the multiply and divide operations can be performed as table-based lookup (LUT) operations.

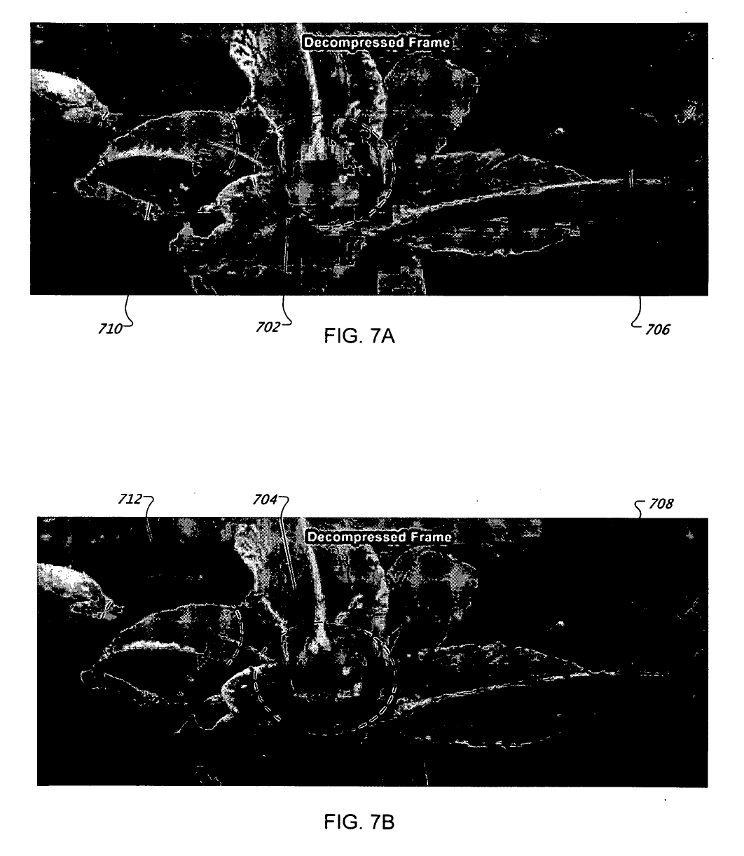

FIGS. 7A and 7B are pictures of a progressive frame of video data before and after deblocking, respectively. Area 702 in FIG. 7A compared to area 704 in FIG. 7B shows a large amount of the blockiness in the picture has been removed while the real edges have been preserved. Area 706 in FIG. 7A compared to area 708 in FIG. 7B shows the retention of the background sharpness. Area 710 in FIG. 7A compared to area 712 in FIG. 7B shows some slight blurring in an area flower that may be caused by pixel filtering and the deblocking algorithm.

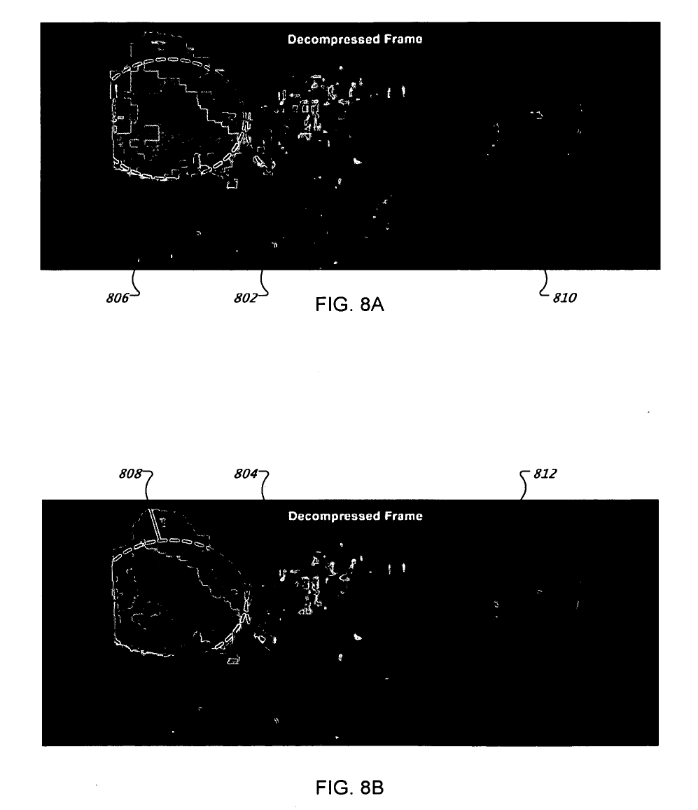

FIGS. 8A and 8B are additional pictures of a progressive frame of video data before and after deblocking, respectively. Area 802 in FIG. 8A compared to area 804 in FIG. 8B shows the flying object in the center of the picture is deblocked, resulting in the clarity of its features being visible in the picture. Area 806 in FIG. 8A compared to area 808 in FIG. 8B show a small amount of blockiness remains in the white smoke. Area 810 in FIG. 8A compared to area 812 in FIG. 8B shows a deblocked background area of the picture. In some implementations, order to smooth the background even more, additional deblocking in this area of the picture could occur.

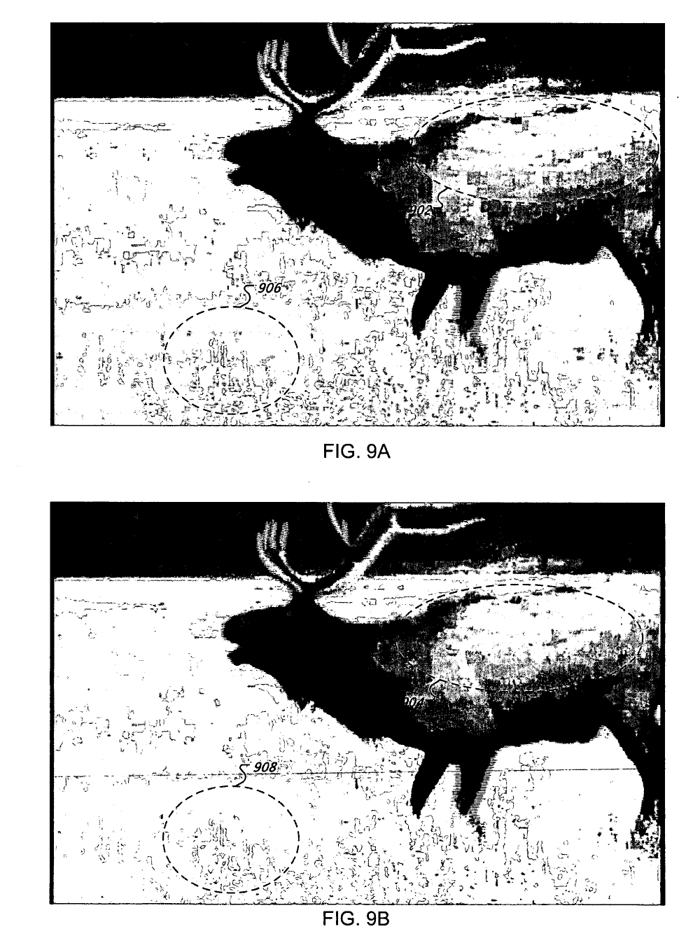

FIGS. 9A and 9B are pictures of an interlaced frame of video data before and after deblocking, respectively. The interlaced frame can include two independently deblocked fields of picture data to produce the one full frame of deblocked picture data. Area 902 in FIG. 9A compared to area 904 in FIG. 9B shows the body of the moose has been deblocked. Area 906 in FIG. 9A compared to area 908 in FIG. 9B show the preservation of the details in the grass.

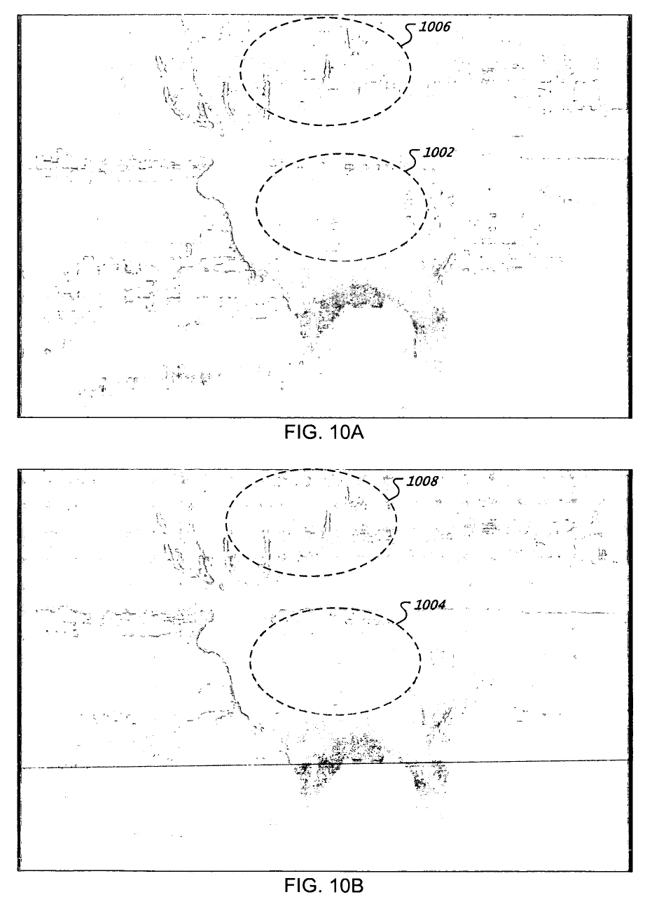

FIGS. 10A and 10B are additional pictures of an interlaced frame of video data before and after deblocking, respectively. The interlaced frame can include two independently deblocked fields of picture data to produce the one full frame of deblocked picture data. The input picture is representative of a dissolve scene. In a dissolve scene, a first scene can fade out as a second scene fades in. A dissolve can be a method of overlapping two frames of video data for a transition effect. In general, the blockiness reduction has caused little, if any, blurring in the picture. Area 1002 in FIG. 10A compared to area 1004 in FIG. 10B shows the body of the mouse has been deblocked. Area 1006 in FIG. 10A compared to area 1008 in FIG. 10B shows the detail remaining in the antlers on the mouse (no additional blurring is added).

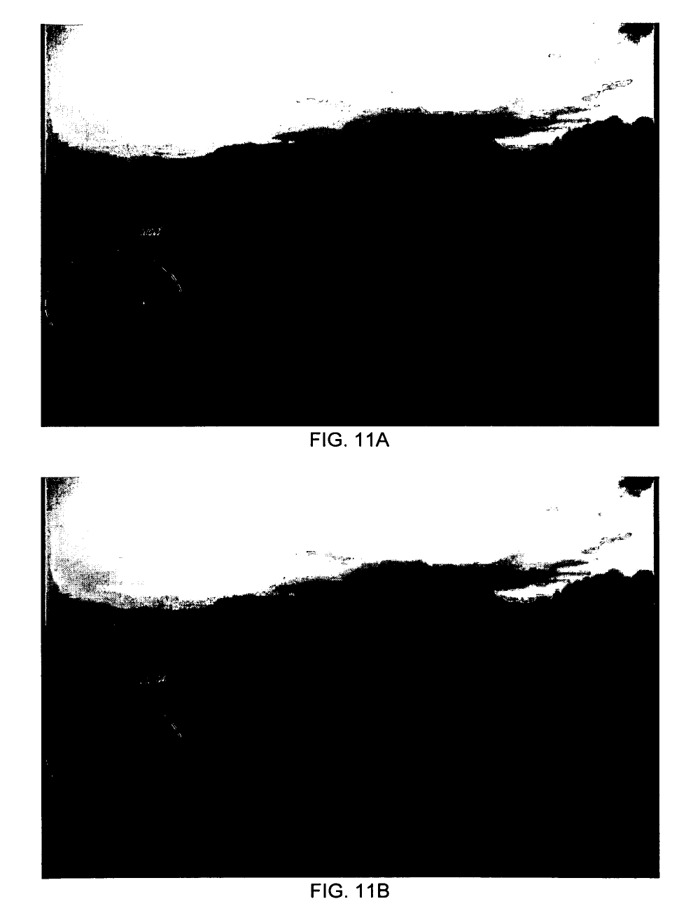

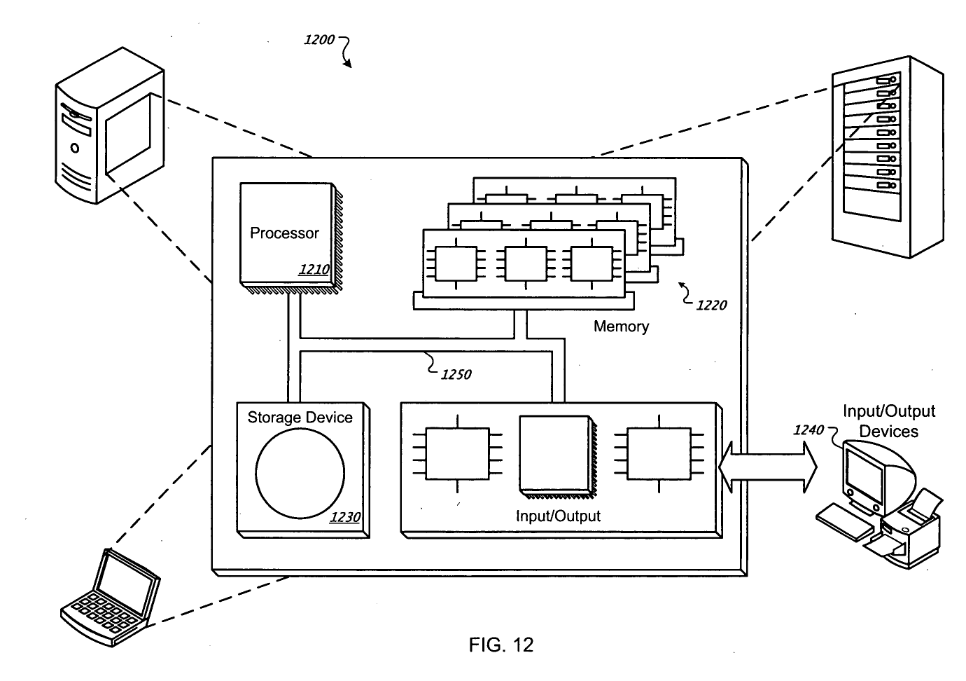

FIGS. 11A and 11B are additional pictures of an interlaced frame of video data before and after deblocking, respectively. The interlaced frame can include two independently deblocked fields of picture data to produce the one full frame of deblocked picture data. In general, the picture in FIG. 11A exhibits a limited amount of blockiness and a good amount of fine spatial detail. The deblocking algorithm can preserve the details in a picture that exhibits a limited amount of blockiness. The details and sharpness in the unblocked picture, as shown in area 1102 in FIG. 11A, are preserved in the deblocked picture with a slight improvement, as shown in area 1104 in FIG. 11B.

### Generic Computer System

FIG. 12 is a block diagram of an implementation of a system for implementing the various operations described in FIGS. 1-6. The system 1200 can be used for the operations described in association with the method 300 according to one implementation. For example, the system 1200 may be included in either or all of the advertising management system 104, the publishers 106, the advertisers 102, and the broadcasters 110.

The system 1200 includes a processor 1210, a memory 1220, a storage device 1230, and an input/output device 1240. Each of the components 1210, 1220, 1230, and 1240 are interconnected using a system bus 1250. The processor 1210 is capable of processing instructions for execution within the system 1200. In one implementation, the processor 1210 is a single-threaded processor. In another implementation, the processor 1210 is a multi-threaded processor. The processor 1210 is capable of processing instructions stored in the memory 1220 or on the storage device 1230 to display graphical information for a user interface on the input/output device 1240.

The memory 1220 stores information within the system 1200. In one implementation, the memory 1220 is a computer-readable medium. In one implementation, the memory 1220 is a volatile memory unit. In another implementation, the memory 1220 is a non-volatile memory unit.

The storage device 1230 is capable of providing mass storage for the system 1200. In one implementation, the storage device 1230 is a computer-readable medium. In various different implementations, the storage device 1230 may be a floppy disk device, a hard disk device, an optical disk device, or a tape device. The storage device 1230 can be used, for example, to store information in the repository 215, the audio content 216, the historical data 218, the video content 220, the search information 222, and the processes/parameters 226.

The input/output device 1240 provides input/output operations for the system 1200. In one implementation, the input/output device 1240 includes a keyboard and/or pointing device. In another implementation, the input/output device 1240 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, the client A 102 and the server 104 may be implemented within the same computer system.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of embodiments of the invention have been described. Nevertheless, it will be understood that various modifications may be made without departing from the spirit and scope of the invention. Accordingly, other embodiments are within the scope of the following claims.

What is claimed is:

1. A method comprising:
receiving a coded video picture, the coded video picture having one or more set of blocks, each block including one or more pixels and at least one block having blocking artifacts;
deblocking the one or more set of blocks in the picture; and
generating a decoded deblocked picture based on the deblocked blocks, the blocking artifacts being substantially removed from the decoded deblocked picture.

2. The method of claim 1, where deblocking the one or more set of blocks in the picture includes:
identifying a diagonal neighborhood associated with the one or more set of blocks, the diagonal neighborhood including at least one or more different set of blocks disposed diagonal to the one or more set of blocks;
evaluating the at least one or more different set of blocks; and
deblocking the one or more blocks in the picture including deblocking the one or more blocks based on the evaluation.

3. The method of claim 2, where identifying a diagonal neighborhood associated with the one or more set of blocks includes locating one or more corner pixels associated with the diagonal neighborhood; and
where deblocking the one or more blocks in the picture includes deblocking the one or more corner pixels twice.

4. A method comprising:
receiving a digital video signal representing a digitally compressed video image including a plurality of pixels arranged horizontally and vertically in a two-dimensional array;
determining one or more pixel values associated with one or more pixels disposed diagonally relative to a pixel;
determining a threshold value based on the one or more pixel values;
comparing the threshold value against one or more parameters associated with the pixel with the blocking artifact; and
filtering the pixel if it is determined that the one or more parameters exceed the threshold value.

5. A method comprising:
receiving a digital video signal representing a digitally compressed video image including a plurality of pixels arranged in a two-dimensional array; and
determining a boundary condition in the received signal, the boundary condition being determined in the digitally compressed video image according to a smoothness measurement associated with one or more pixels arranged in a diagonal direction.

6. A method comprising:
identifying a macro-block associated with a blocking artifact, the macro-block having a plurality of pixels and including a uniform block corresponding to a region having substantially uniform pixel values and a non-uniform block corresponding to a region having non-uniform pixel values;
calculating a gradient value for each pixel;
comparing the gradient value to a threshold value to determine one or more pixels associated with a blocking artifact; and
filtering the one or more pixels whose gradient value exceeds the threshold value.

7. A method comprising:
receiving a portion of an image, the portion including a boundary and first and second contiguous pixels disposed on opposite sides of the boundary, the first and second pixels having respective first and second pixel values;
determining a boundary value from the first and second values;
comparing the boundary value against a threshold value; and
minimizing a difference between the first and second values if the boundary value exceeds the threshold value.

8. A method as defined in claim 7, further comprising selecting a deblocking filter strength to be applied in response to the threshold value.

9. A method comprising:
detecting one or more discontinuities in proximity to block boundaries of an image;
determining whether any of the discontinuities are artificial discontinuities based on a threshold value; and
smoothing the one or more discontinuities that are determined to be artificial discontinuities.

10. A system comprising:
a processor; and
computer-readable medium coupled to the processor and having instructions stored thereon, which, when executed by the processor, causes the processor to perform operations comprising:
receiving a coded video picture, the coded video picture having one or more set of blocks, each block including one or more pixels and at least one block having blocking artifacts;
deblocking the one or more set of blocks in the picture; and
generating a decoded deblocked picture based on the deblocked blocks, the blocking artifacts being substantially removed from the decoded deblocked picture.

11. A system comprising:
a processor; and
computer-readable medium coupled to the processor and having instructions stored thereon, which, when executed by the processor, causes the processor to perform operations comprising:
receiving a digital video signal representing a digitally compressed video image including a plurality of pixels arranged horizontally and vertically in a two-dimensional array;
determining one or more pixel values associated with one or more pixels disposed diagonally relative to a pixel;
determining a threshold value based on the one or more pixel values;
comparing the threshold value against one or more parameters associated with the pixel with the blocking artifact; and
filtering the pixel if it is determined that the one or more parameters exceed the threshold value.

12. A system comprising:
a processor; and
computer-readable medium coupled to the processor and having instructions stored thereon, which, when executed by the processor, causes the processor to perform operations comprising:
receiving a digital video signal representing a digitally compressed video image including a plurality of pixels arranged in a two-dimensional array; and
determining a boundary condition in the received signal, the boundary condition being determined in the digitally compressed video image according to a smoothness measurement associated with one or more pixels arranged in a diagonal direction.

13. A system comprising:
a processor; and
computer-readable medium coupled to the processor and having instructions stored thereon, which, when executed by the processor, causes the processor to perform operations comprising:
identifying a macro-block associated with a blocking artifact, the macro-block having a plurality of pixels and including a uniform block corresponding to a region having substantially uniform pixel values and a non-uniform block corresponding to a region having non-uniform pixel values;
calculating a gradient value for each pixel;
comparing the gradient value to a threshold value to determine one or more pixels associated with a blocking artifact; and
filtering the one or more pixels whose gradient value exceeds the threshold value.

14. A system comprising:
a processor; and
computer-readable medium coupled to the processor and having instructions stored thereon, which, when executed by the processor, causes the processor to perform operations comprising:
receiving a portion of an image, the portion including a boundary and first and second contiguous pixels disposed on opposite sides of the boundary, the first and second pixels having respective first and second pixel values;
determining a boundary value from the first and second values;
comparing the boundary value against a threshold value; and
minimizing a difference between the first and second values if the boundary value exceeds the threshold value.

15. A system comprising:
a processor; and
computer-readable medium coupled to the processor and having instructions stored thereon, which, when executed by the processor, causes the processor to perform operations comprising:
detecting one or more discontinuities in proximity to block boundaries of an image;
determining whether any of the discontinuities are artificial discontinuities based on a threshold value; and
smoothing the one or more discontinuities that are determined to be artificial discontinuities.

16. A computer-readable medium having instructions stored thereon, which, when executed by a processor, causes the processor to perform operations comprising:
receiving a coded video picture, the coded video picture having one or more set of blocks, each block including one or more pixels and at least one block having blocking artifacts;
deblocking the one or more set of blocks in the picture; and
generating a decoded deblocked picture based on the deblocked blocks, the blocking artifacts being substantially removed from the decoded deblocked picture.

17. A computer-readable medium having instructions stored thereon, which, when executed by a processor, causes the processor to perform operations comprising:
receiving a digital video signal representing a digitally compressed video image including a plurality of pixels arranged horizontally and vertically in a two-dimensional array;
determining one or more pixel values associated with one or more pixels disposed diagonally relative to a pixel;
determining a threshold value based on the one or more pixel values;
comparing the threshold value against one or more parameters associated with the pixel with the blocking artifact; and
filtering the pixel if it is determined that the one or more parameters exceed the threshold value.

18. A computer-readable medium having instructions stored thereon, which, when executed by a processor, causes the processor to perform operations comprising:
receiving a digital video signal representing a digitally compressed video image including a plurality of pixels arranged in a two-dimensional array; and
determining a boundary condition in the received signal, the boundary condition being determined in the digitally compressed video image according to a smoothness measurement associated with one or more pixels arranged in a diagonal direction.

19. A computer-readable medium having instructions stored thereon, which, when executed by a processor, causes the processor to perform operations comprising:
identifying a macro-block associated with a blocking artifact, the macro-block having a plurality of pixels and including a uniform block corresponding to a region having substantially uniform pixel values and a non-uniform block corresponding to a region having non-uniform pixel values;
calculating a gradient value for each pixel;
comparing the gradient value to a threshold value to determine one or more pixels associated with a blocking artifact; and
filtering the one or more pixels whose gradient value exceeds the threshold value.

20. A computer-readable medium having instructions stored thereon, which, when executed by a processor, causes the processor to perform operations comprising:
receiving a portion of an image, the portion including a boundary and first and second contiguous pixels disposed on opposite sides of the boundary, the first and second pixels having respective first and second pixel values;
determining a boundary value from the first and second values;
comparing the boundary value against a threshold value; and
minimizing a difference between the first and second values if the boundary value exceeds the threshold value.

21. A computer-readable medium having instructions stored thereon, which, when executed by a processor, causes the processor to perform operations comprising:
detecting one or more discontinuities in proximity to block boundaries of an image;
determining whether any of the discontinuities are artificial discontinuities based on a threshold value; and
smoothing the one or more discontinuities that are determined to be artificial discontinuities.

22. A system comprising:
means for receiving a coded video picture, the coded video picture having one or more set of blocks, each block including one or more pixels and at least one block having blocking artifacts;
means for deblocking the one or more set of blocks in the picture; and
means for generating a decoded deblocked picture based on the deblocked blocks, the blocking artifacts being substantially removed from the decoded deblocked picture.

23. A system comprising:
means for receiving a digital video signal representing a digitally compressed video image including a plurality of pixels arranged horizontally and vertically in a two-dimensional array;
means for determining one or more pixel values associated with one or more pixels disposed diagonally relative to a pixel;
means for determining a threshold value based on the one or more pixel values;
means for comparing the threshold value against one or more parameters associated with the pixel with the blocking artifact; and
means for filtering the pixel if it is determined that the one or more parameters exceed the threshold value.

24. A system comprising:
means for receiving a digital video signal representing a digitally compressed video image including a plurality of pixels arranged in a two-dimensional array; and
means for determining a boundary condition in the received signal, the boundary condition being determined in the digitally compressed video image according to a smoothness measurement associated with one or more pixels arranged in a diagonal direction.

25. A system comprising:
means for identifying a macro-block associated with a blocking artifact, the macro-block having a plurality of pixels and including a uniform block corresponding to a region having substantially uniform pixel values and a non-uniform block corresponding to a region having non-uniform pixel values;
means for calculating a gradient value for each pixel;
means for comparing the gradient value to a threshold value to determine one or more pixels associated with a blocking artifact; and
means for filtering the one or more pixels whose gradient value exceeds the threshold value.

26. A system comprising:
means for receiving a portion of an image, the portion including a boundary and first and second contiguous pixels disposed on opposite sides of the boundary, the first and second pixels having respective first and second pixel values;
means for determining a boundary value from the first and second values;
means for comparing the boundary value against a threshold value; and
means for minimizing a difference between the first and second values if the boundary value exceeds the threshold value.

27. A system comprising:
means for detecting one or more discontinuities in proximity to block boundaries of an image;
means for determining whether any of the discontinuities are artificial discontinuities based on a threshold value; and
means for smoothing the one or more discontinuities that are determined to be artificial discontinuities.
